(19) United States
(12) Patent Application Publication
(10) Pub. No.: US 2014/0032590 A1
(43) Pub. Date: Jan. 30, 2014

(54) WINDOWED MID-TIER DATA CACHE

(71) Applicants: Russell Mark Sinclair, New York, NY (US); Saurin Bipin Shah, Kirkland, WA (US); Nishant Kumar, Redmond, WA (US); Alexander Alexandrovich Spiridonov, Redmond, WA (US)

(72) Inventors: Russell Mark Sinclair, New York, NY (US); Saurin Bipin Shah, Kirkland, WA (US); Nishant Kumar, Redmond, WA (US); Alexander Alexandrovich Spiridonov, Redmond, WA (US)

(73) Assignee: MICROSOFT CORPORATION, Redmond, WA (US)

(21) Appl. No.: 13/559,628

(22) Filed: Jul. 27, 2012

(51) Int. Cl. G06F 17/30

(52) U.S. Cl. 707/769; 707/E17.005; 707/E17.014

(57) ABSTRACT

Technologies are described herein for implementing a windowed mid-tier data cache. A request is received for a data page comprising a set of data rows from a result set of a query in a database management system (“DBMS”). A determination is made whether the requested data rows exist in the mid-tier cache. If the requested rows exist in the cache, then the set of data rows is retrieved from the cache and the requested data page is returned. If the requested rows do not exist in the cache, a data chunk comprising a number of data rows from the result set larger than and encompassing the requested rows is requested from the DBMS. Upon receiving the data chunk, the data chunk is stored in the mid-tier cache, and the set of data rows are retrieved from the cache and the requested data page is returned.

### BACKGROUND

A user may utilize a client application executing on a personal computer to access data in a database management system (“DBMS”). For example, the user may submit a query to be executed against database tables maintained in the DBMS through a website and then view the resulting rows of data in a Web browser application. Returning an entire result set from a database query over a Web connection may be inefficient, however, because users rarely need to view all of the data and transmitting large result sets may be unreliable and lead to poor performance. In order to mitigate these issues, many Web-based data presentation tools utilize a paging scheme, where the DBMS returns a limited amount of data (e.g. a specific number of records) from the result set for viewing by the user. This specific amount of data is referred to herein as a “data page.” The user may then navigate forward and backward through the data pages comprising the result set.

However, many DBMS servers do not process requests for a small number of records in a data page any more efficiently than a request for the entire result set. Some configurations may further include an intervening service, or “mid-tier server,” that processes the data page requests from the client application. Upon receiving the first data page request for a query, the mid-tier server may request the entire result set from the DBMS, and cache the result set in a cache. The mid-tier server can then respond to subsequent data page requests from the cache without going back to the DBMS. While this results in the query only being run once by the DBMS, any request for just a single data page results in the entire result set being retrieved from the DBMS and cached in the mid-tier server. In addition, when dealing with large result sets, this solution may not scale well.

It is with respect to these considerations and others that the disclosure made herein is presented.

### SUMMARY

Technologies are described herein for implementing a windowed mid-tier data cache. Utilizing the technologies described herein, a mid-tier cache may be implemented that caches in the mid-tier a portion, or “window,” of an entire result set from the execution of a query on a DBMS. The windowed cache may be optimized for retrieval by a forms layer of a client application utilizing a paging scheme to navigate forward and backward through data pages comprising the result set over a network. The use of a windowed cache in the mid-tier, as opposed to caching an entire result set, for example, may reduce the resource load and increase scalability of mid-tier data services provided to the client applications.

According to embodiments, a request is received from a client application by a mid-tier service for a data page comprising a set of data rows from a result set of a query in a database management system. A determination is made whether the requested data rows exist in a cache maintained by the mid-tier service. If the requested data rows exist in the cache, then the set of data rows is retrieved from the cache and the requested data page is returned to the client application. If the requested data rows do not exist in the cache, a data chunk comprising a number of data rows from the result set is requested from the database management system. The number of data rows comprising the data chunk may be larger than and encompass the requested set of data rows. Upon receiving the data chunk from the database management system, the data chunk is stored in the cache, and the requested data rows are retrieved from the cache and the requested data page is returned to the client application.

It will be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing aspects of an illustrative operating environment and software components provided by some embodiments presented herein;

FIG. 2 is a data diagram showing data elements contained in an illustrative request, according to some embodiments described herein;

FIG. 3 is a screen diagram showing an illustrative user interface showing the display of data retrieved from a database management system through a windowed mid-tier data cache, according to some embodiments described herein;

FIGS. 4A-4J are block diagrams showing aspects of the operation of a windowed mid-tier data cache, according to some embodiments described herein;

FIG. 5 is a flow diagram showing one method for processing data page requests from a client utilizing a windowed mid-tier data cache, according to some embodiments described herein;

FIG. 6 is a block diagram showing an illustrative computer hardware architecture for a computing system capable of implementing aspects of the embodiments presented herein; and

FIG. 7 is a block diagram illustrating a distributed computing environment capable of implementing aspects of the embodiments presented herein.

### DETAILED DESCRIPTION

The following detailed description is directed to technologies for implementing a windowed mid-tier data cache. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, distributed systems, and the like.

In the following detailed description, references are made to the accompanying drawings that form a part hereof and that show, by way of illustration, specific embodiments or examples. In the accompanying drawings, like numerals represent like elements through the several figures.

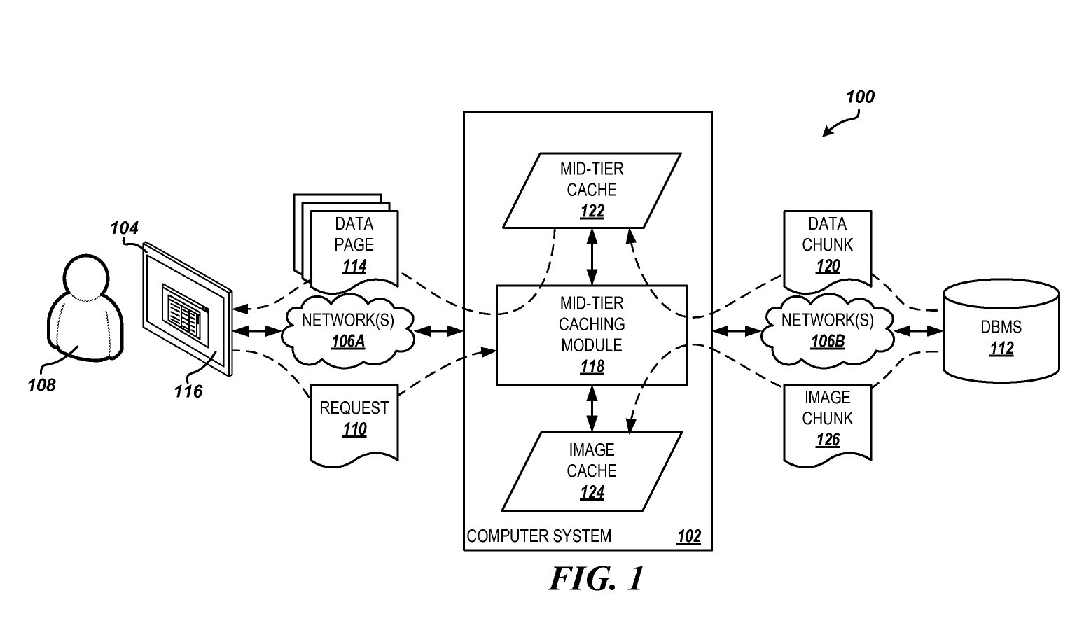

FIG. 1 shows an illustrative operating environment 100 including software components for implementing a windowed mid-tier data cache, according to embodiments provided herein. The environment 100 includes a computer system 102. The computer system 102 may represent an application server, Web server, database server, or the like. The computer system 102 may be a component of a cloud-based computing platform comprising application servers, Web servers, database servers, storage systems, network appliances, dedicated hardware devices, and/or other server computers or computing devices known in the art. Alternatively, the computer system 102 may represent other computing platforms known in the art. The computer system 102 may be connected to a user computing device 104, such as the tablet computer shown in FIG. 1, by one or more networks 106A. The user computing device 104 may alternatively comprise a personal computer (“PC”), a server computer, a laptop, a notebook, a personal digital assistant (“PDA”), a smart phone, a game console, a set top box, or any other computing device known in the art. The networks 106A may comprise LANs, WANs, the Internet, or a combination of these and other networking infrastructure known in the art.

In some embodiments, a user 108 may utilize a client application executing on the user computing device 104 to submit a request 110 to the computer system 102 to retrieve data from a database management system (“DBMS”) 112. The client application may be a Web browser application executing a Web-based application retrieved from the computer system 102 or other Web server in a cloud-based computing platform, for example. In other embodiments, the client application may be any data retrieval application executing on the user computing device 104, the computer system 102, and/or other server computers connected to the network(s) 106A. The computer system 102 may implement the DBMS 112, or the DBMS may be implemented by one or more database servers and the like connected to the computer system 102 over one or more networks 106B. The network(s) 106B may be the same network(s) 106A that connect the user computing device 104 to the computer system 102, may include one or more overlapping networks, or may be independent networks, such as internal LANs of a cloud-based computing platform. The network(s) 106A and 106B are also referred to herein generally as network(s) 106.

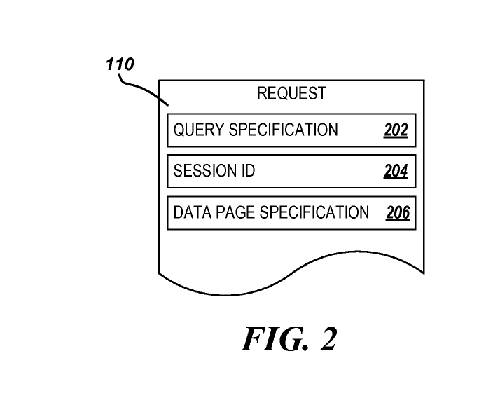

As shown in FIG. 2, the request 110 may include a query specification 202 identifying a query to be executed against database tables maintained in the DBMS 112. The query specification 202 may comprise a query in a standard query language, such as structured query language (“SQL”), an identifier or a query stored in the DBMS 112, an identifier of a previously executed query, or the like. The request 110 may also include a session identifier 204 identifying the user computing device 104, the client application, and/or the like associated with the query specification 202. For example, the session identifier 204 may comprises a session ID from a Web browser application. The request 110 may further include a data page specification 206. The data page specification 206 may specify a sequence of rows from the overall result set of the query to be returned, referred to herein as a data page 114. In some embodiments, the data page specification 206 may comprise a row index indicating a position of the first row requested in the data rows of the result set along with a row count, also referred to herein as “page size,” indicating the number of sequential rows to be returned. It will be appreciated that the request 110 may contain additional and/or alternative data items to those shown in FIG. 2 and described herein.

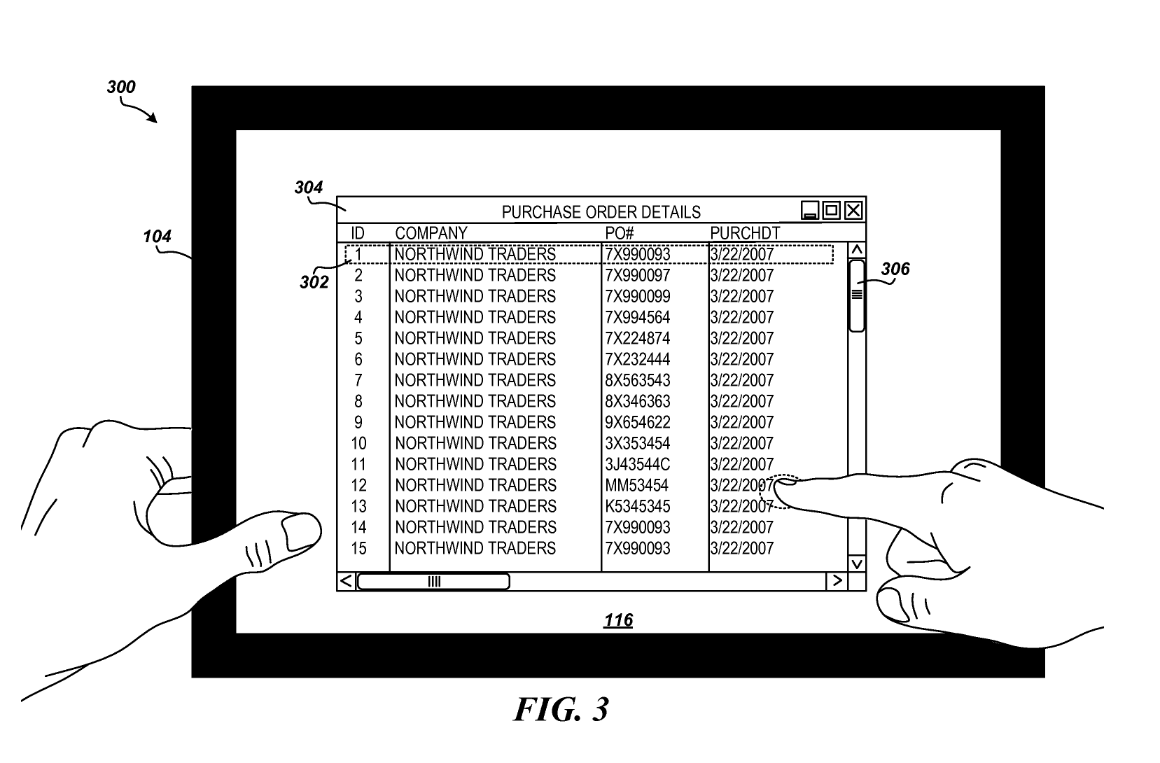

The client application may be configured to display the rows from the data from the requested data page 114 on a display of the user computing device 104, such as a touchscreen 116 of the tablet computer. For example, the client application may display a user interface (“UI”) 300 on the touchscreen 116 that includes the data rows of the data page 114, such as data row 302, listed in a window 304, as shown in FIG. 3. It will be appreciated that the page size may be the same as or different from the number of data rows 302 visible in the window 304 at one time. The UI 300 may further include paging UI controls that allow the user 108 to navigate through the various data pages 114 that make up the complete result set of the query. For example, the UI 300 may include a vertical scrollbar UI control 306 in the window 304 that allows the user 108 to scroll through the data pages 114 that make up the result set. The vertical scrollbar UI control 306 may be sized and positioned such to reflect the number of total rows in the result set 402 and a relative position of the number of data rows 302 visible in the window 304 within the entire result set. In other embodiments, the paging UI controls may additionally or alternatively include a display of a total row count for the result set, the total number of data pages 114 in the result set (e.g. based on the page size), an indicator of the index of the currently displayed data page within the total number of data pages, UI controls to allow the user to move forward and backward through the data pages, and the like.

Returning now to FIG. 1, a mid-tier caching module 118 executes in the computer system 102, according to embodiments. The mid-tier caching module 118 may process the requests 110 for data received from the client application executing on the user computing device 104. The mid-tier caching module 118 may be implemented as hardware, software, or a combination of the two. In addition, the mid-tier caching module 118 may comprise any number of application program modules and other components on the computer system 102 and/or other computing platforms. Upon receiving the request 110 from the user computing device 104, the mid-tier caching module 118 may then forward the query specification 202 or other query identifier from the request to the DBMS 112 over the network(s) 106B for execution.

The mid-tier caching module 118 may further specify a specific set of data rows in the result set, referred to herein as a data chunk 120, to be returned from the DBMS upon execution of the query. The data chunk 120 may represent a subset of the total result set from the query execution, as will be described in more detail below. Upon executing the specified query, the DBMS 112 may return the data chunk 120 to the mid-tier caching module 118 over the networks(s) 106B. The mid-tier caching module 118 may then store the data chunk 120 in a mid-tier cache 122. The mid-tier cache 122 may be maintained in the main memory of the computer system 102, in a data storage device of the computer system, and/or in a data storage system connected to the computer system, for example.

According to embodiments, the mid-tier caching module 118 maintains a “cache window” of sequential data rows in the mid-tier cache 122. The specification of the sequential data rows to be retrieved from the DBMS 112 and stored in the mid-tier cache 122 may be established such that the rows in the cache window encompass the requested rows from the data page specification 206 received in the request 110. For example, the data rows retrieved from the DBMS 112 and stored in the cache window may be substantially centered around the requested rows. In some embodiments, the number of data rows maintained in the cache window may be a multiple of the page size from the request 110. For example, for a requested page size of 20 rows, the mid-tier caching module 118 may maintain 60 (3× multiple) data rows substantially centered around the requested 20 rows. This may allow the mid-tier caching module 118 to respond to subsequent requests 110 from the user computing device 104 for either the next or previous data page 114 from the mid-tier cache 122, without having to resend the query to the DBMS 112. In other embodiments, the number of rows requested for each data chunk 120 and maintained in the cache window may be a configurable number of rows, such as 100 rows, determined by optimization analysis or the like.

According to some embodiments, the cache window maintained in the mid-tier cache 122 may be associated with a particular “session” between the client application executing on the user computing device 104 and the mid-tier caching module 118 and/or other mid-tier services. The mid-tier caching module 118 may use the session identifier 204, the query specification 202, and/or other data fields from the request as a key to the session and associated cache window in the mid-tier cache 122. In further embodiments, the mid-tier caching module 118 may also maintain state information regarding the caching operation associated with the session and the cache window maintained in the mid-tier cache 122. The state information may include an actual or estimated total row count for the result set of the query, the row indices of the data rows in the cache window, the query specification 202 and/or session identifier 204 received in the request, a query or result set identifier returned from the DBMS 112, and the like. By maintaining state information regarding the caching operations, the mid-tier caching module 118 may make requests to the DBMS 112 for data chunks 120 for the cache window in a stateless fashion.

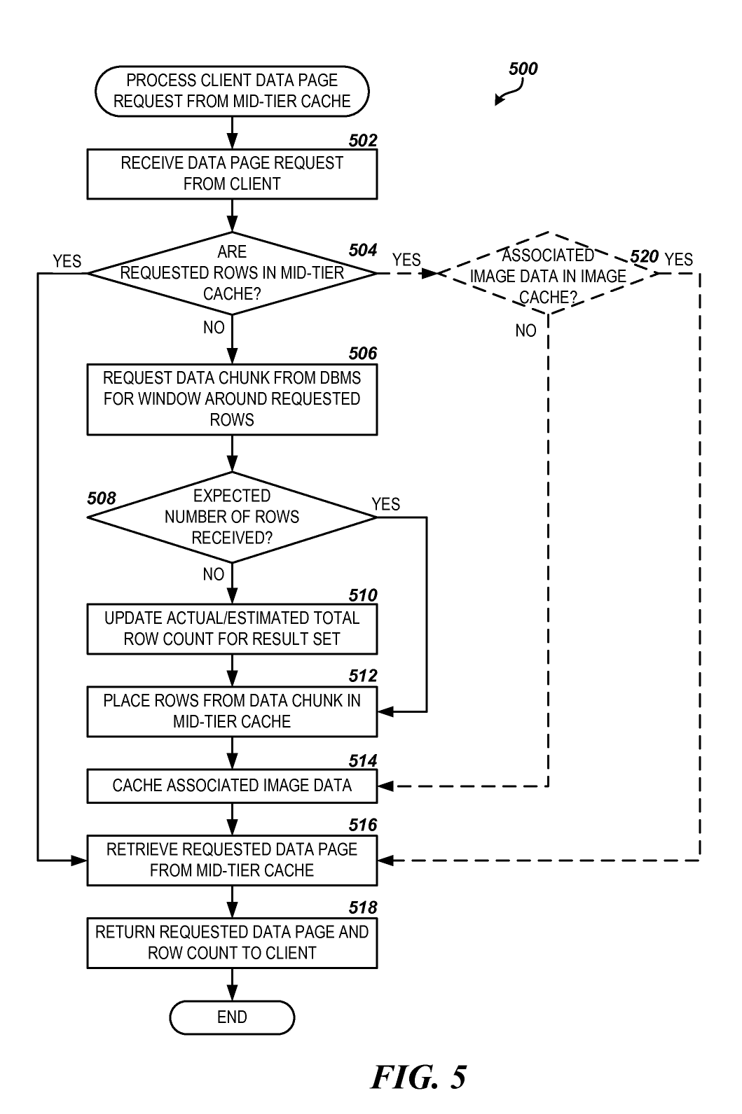

After storing the data chunk 120 in the mid-tier cache 122, the mid-tier caching module 118 may then process the request 110 received from the user computing device 104 by returning a data page 114 containing the requested rows from the mid-tier cache, as will be described below in detail in regard to FIG. 5. As will become apparent below, the mid-tier caching module 118 may also process subsequent requests 110 for other data pages 114 in the same session from the cache window in the mid-tier cache 122, without having to resend the query to the DBMS 112. In some embodiments, the cache window associated with the session may timeout after some period of time of inactivity within the session, such as 5 minutes. If no requests are received from the user computing device 104 in the session, e.g. associated with the query specification 202 and/or session identifier 204, for example, in that period of time, the mid-tier caching module 118 may discard the associated cache window from the mid-tier cache 122.

In further embodiments, the mid-tier caching module 118 may also maintain an image cache 124. The image cache 124 may be maintained in the main memory of the computer system 102, for example. The mid-tier caching module 118 may maintain the image cache 124 in parallel with the mid-tier cache 122. The mid-tier caching module may request image data associated with the data rows returned in a data chunk 120 from the DBMS 112 and stored in the cache window in the mid-tier cache 122. The DBMS 112 may return one or more image chunks 126 containing the associated image data, and the mid-tier caching module 118 may store the image chunks in the image cache 124. The mid-tier cache module 118 may cache the associated image data after receiving the data chunk 120 from the DBMS 112, and respond to requests from the client application on the user computing device 104 for the cached images from the image cache 124 when the image data becomes available.

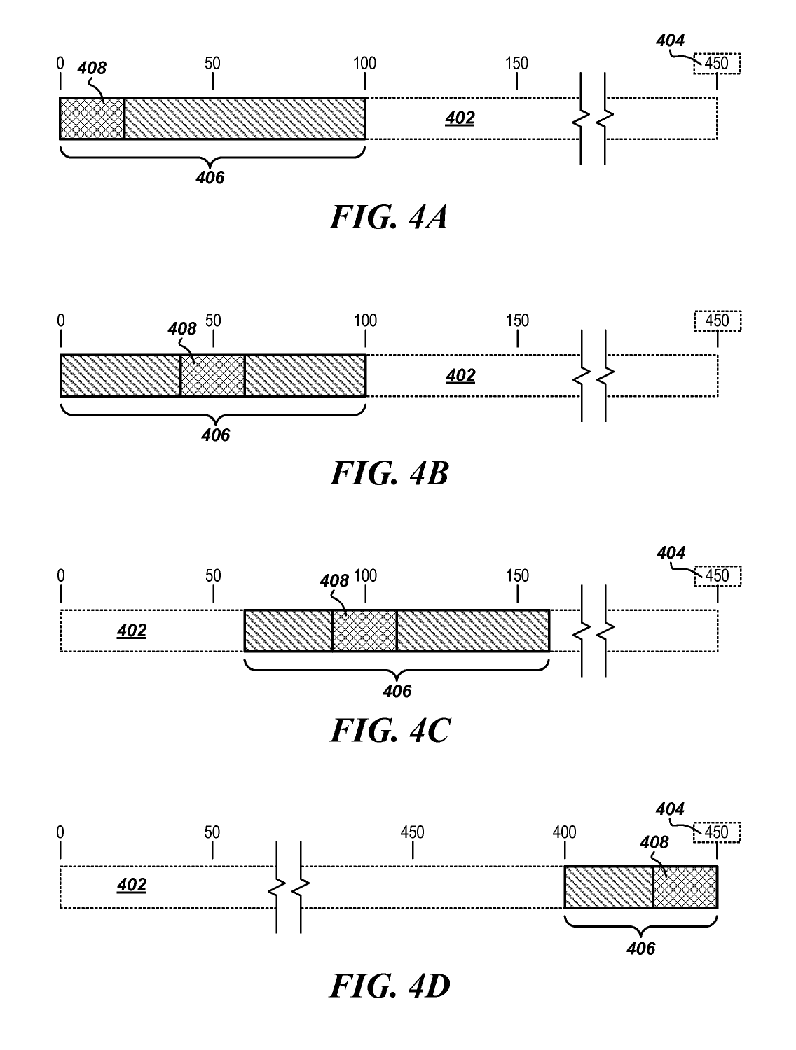

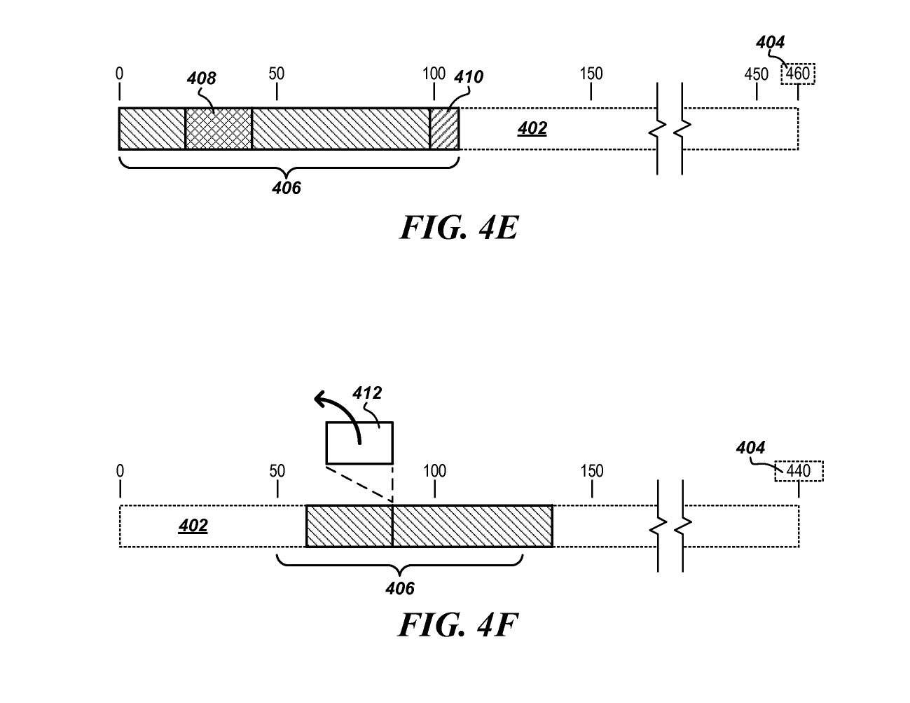

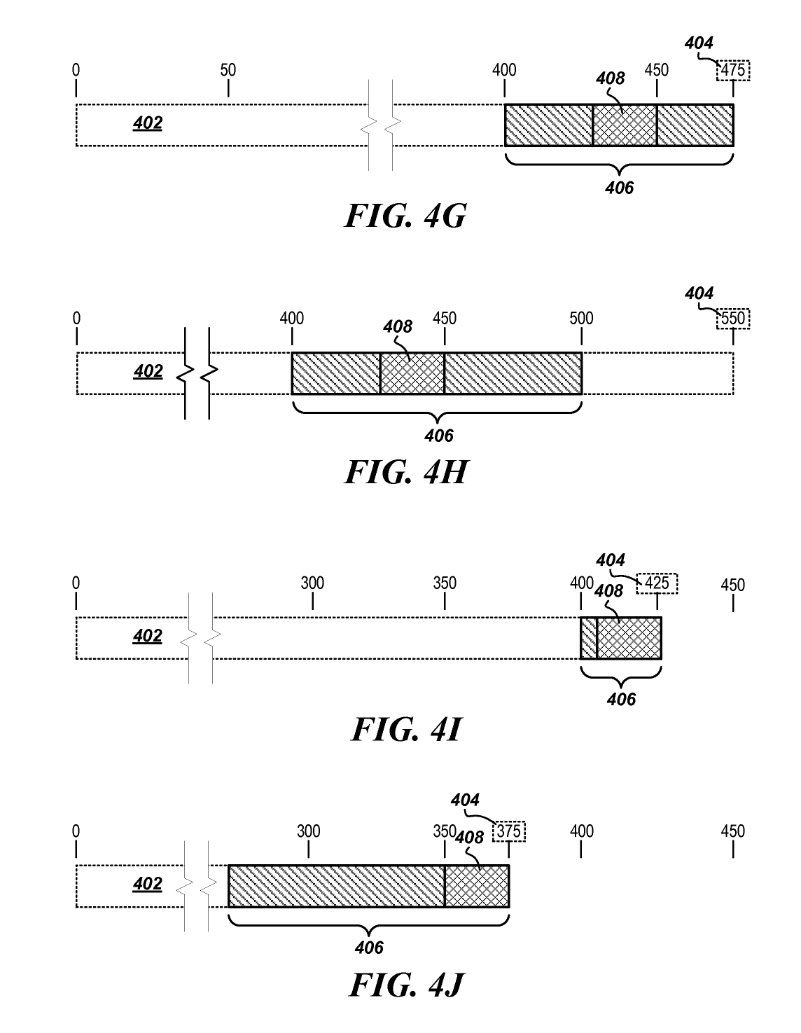

FIGS. 4A-4J show additional aspects of the operation of the mid-tier caching module 118 in maintaining the cache window in the mid-tier cache 122, according to some embodiments. In the following scenarios, requests 110 are received by the mid-tier caching module 118 from the user computing device 104 that include a query specification 202 that results in a total result set of approximately 450 rows in the DBMS 112, as indicated at 402 in FIG. 4A. The size of the cache window, or “cache size,” is configured to be 100 rows. The initial request 110 may further include a data page specification 206 indicating that a data page 114 comprising the first 20 rows, i.e. page size of 20, from the result set is to be returned.

In response to the initial request, the mid-tier caching module 118 may forward the query specification 202 to the DBMS 112 specifying that the first 100 rows of the result set 402 be returned. The DBMS 112 may return a data chunk 120 comprising the first 100 rows from the query execution. In some embodiments, the DBMS 112 may further return an actual or estimate total row count for the result set, as indicated at 404 in FIG. 4A. As illustrated in FIG. 4A, the mid-tier caching module 118 may establish a new cache window in the mid-tier cache and store the 100 rows from the data chunk 120 in the cache window, as indicated at 406. The mid-tier caching module 118 then retrieves the requested first 20 rows, as indicated at 408, from the cache window 406 and returns a data page 114 containing the retrieved rows to the user computing device 104. The data page 114 may further include the actual/estimated total row count 404 received from the DBMS 112, which may be used by the client application on the user computing device 104 to update the paging UI controls in the UI 300, for example.

A subsequent request may be received by the mid-tier caching module 118 with a data page specification 206 requesting rows 40-60 from the result set 402. As illustrated in FIG. 4B, the mid-tier caching module 118 may determine that the requested rows exist in the cache window 406 associated with the query specification 202 and/or session identifier 204 in the mid-tier cache 122, as indicated at 408. The mid-tier caching module 118 may retrieve the requested rows 408 from the cache window 406 and return a data page 114 containing the retrieved rows to the user computing device 104. The data page 114 may further include the actual/estimated total row count 404 from the status information associated with the cache window 406.

A subsequent request may be received by the mid-tier caching module 118 with a data page specification 206 requesting rows 90-110 from the result set 402. The mid-tier caching module 118 may determine that all of the requested rows do not exist in the cache window 406. The mid-tier caching module 118 may then re-send the query specification 202 to the DBMS 112 specifying that 100 rows encompassing the requested rows of the result set 402 be returned. For example, the mid-tier caching module 118 may request rows 60-160 of the result set 402. The DBMS 112 may return a data chunk 120 comprising the rows 60-160 from the query execution. The mid-tier caching module 118 may establish a new cache window in the mid-tier cache and store the 100 rows from the data chunk 120 in the cache window, as indicated at 406 in FIG. 4C.

The mid-tier caching module 118 may then retrieve the requested rows 408 from the cache window 406 and return a data page 114 containing the retrieved rows to the user computing device 104. As described above, the data page 114 may further include the actual/estimated total row count 404 for the result set. In some embodiments, the DBMS may return a new actual/estimated total row count 404 for the result set 402 each time a data chunk 120 is requested by the mid-tier caching module 118. The actual/estimated total row count 404 returned with the data page 114 may either be the newly returned count from the DBMS 112, if available, or that from the status information associated with the cache window 406.

A subsequent request may be received by the mid-tier caching module 118 with a data page specification 206 requesting the last 20 rows, i.e. rows 430-450, from the result set 402. As before, the mid-tier caching module 118 may determine that all of the requested rows do not exist in the cache window 406. The mid-tier caching module 118 may then re-send the query specification 202 to the DBMS 112 specifying that 100 rows encompassing the requested rows be returned, such as rows 400-500 of the result set 402. The DBMS 112 may return a data chunk 120 comprising the rows 400-450 from the query execution, since only 450 rows exist in the result set 402. The mid-tier caching module 118 may establish a new cache window in the mid-tier cache 122 and store the 50 rows from the data chunk 120 in the cache window, as indicated at 406 in FIG. 4D. The mid-tier caching module 118 may then retrieve the requested rows 408 from the cache window 406 and return a data page 114 containing the retrieved rows and the actual/estimated total row count 404 to the user computing device 104.

According to further embodiments, the mid-tier caching module 118 may further handle insert and delete requests from the client application on the user computing device 104 in regard to the currently active query/result set 402. In addition to forwarding the insert and delete requests to the DBMS 112 for execution against the specified data tables, the mid-tier caching module 118 may expand the cache window 406 for inserts or reduce the cache window for deletes appropriately, until such time as a request is received from the user computing device for rows outside of the boundaries of the cache window.

For example, after the initial request 110 is processed by the mid-tier caching module 118, as described above in regards to FIG. 4A, the mid-tier caching module 118 may receive a request from the client to insert 10 rows at a row index at the end of the currently viewed data page 114 in the cache window 406. The newly inserted rows may comprise rows 40-50 of the result set 402, for example. Upon forwarding the insert request to the DBMS 112, the mid-tier caching module 118 may insert the new rows at the end of the cache window 406, as indicated at 410 in FIG. 4E. It will be appreciated that this may result in the cache size for the cache window 406 temporarily increasing to 110 rows. In addition, the mid-tier caching module 118 may update the actual/estimated total row count 404 to reflect the addition of the 10 rows along with modifying the row indices associated with the data rows in the cache window 406 accordingly.

Similarly, after processing the request 110 described above in regards to FIG. 4C, the mid-tier caching module 118 may receive a request from the client to delete 20 rows that are currently in the cache window 406. The rows to be deleted may comprise rows 85-105 of the result set 402, for example. Upon forwarding the delete request to the DBMS 112, the mid-tier caching module 118 may remove the deleted rows from the cache window 406, as indicated at 412 in FIG. 4F. It will be appreciated that this may result in the cache size for the cache window 406 temporarily decreasing to 80 rows. In addition, the mid-tier caching module 118 may update the actual/estimated total row count 404 to reflect the removal of the 20 rows along with modifying the row indices associated with the data rows in the cache window 406 accordingly.

It will be further appreciated that changes to the result set 402 associated with the active query, such as inserts and deletes, made in the DBMS 112 external to the current session between the client application on the user computing device 104 and the mid-tier caching module 118 may not be reflected in any cache window 406 maintained in the mid-tier cache 122 or in any status information associated with the cache window, such as the actual/estimated total row count 404. This may yield inconsistent rows in data pages 114 retrieved from the cache window 406 or over cache boundaries as the cache window is rebuilt from the DBMS 112.

For example, after the initial request 110 is processed by the mid-tier caching module 118, as described above in regards to FIG. 4A, a subsequent request may be received by the mid-tier caching module 118 with a data page specification 206 requesting the last 20 rows, i.e. rows 430-450, from the result set 402 of the currently active query. Upon determining that all of the requested rows do not exist in the cache window 406, the mid-tier caching module 118 may re-send the query specification 202 to the DBMS 112 specifying that 100 rows encompassing the requested rows be returned, such as rows 400-500 of the result set 402.

Since the last actual/estimated total row count 404 received indicates that the result set 402 comprises 450 rows, the mid-tier caching module 118 may only expect 50 rows to be returned from the DBMS 112. If 25 additional rows have been inserted into the data tables comprising the result set 402 in the interim, the DBMS 112 may return a data chunk 120 comprising the rows 400-475 from the query execution. The mid-tier caching module 118 may establish a new cache window in the mid-tier cache 122 and store the 75 rows from the data chunk 120 in the cache window, as indicated at 406 in FIG. 4G. The mid-tier caching module 118 may further update the actual/estimated total row count 404 for the result set 402 to indicate 475 rows. The mid-tier caching module 118 may then retrieve the requested rows 408 from the cache window 406 and return a data page 114 containing the retrieved rows and the updated actual/estimated total row count 404 to the user computing device 104.

However, if 100 additional rows have been inserted into the data tables comprising the result set 402, the DBMS 112 may return a data chunk 120 comprising the rows 400-500 from the query execution. The mid-tier caching module 118 may establish a new cache window in the mid-tier cache 122 and store the 100 rows from the data chunk 120 in the cache window, as indicated at 406 in FIG. 4H. The mid-tier caching module 118 may further detect that the current value for the actual/estimated total row count 404 for the result set 402 is invalid, and request a new actual or estimate total row count from the DBMS 112. The mid-tier caching module 118 may then retrieve the requested rows 408 from the cache window 406 and return a data page 114 to the user computing device 104 containing the retrieved rows and the new actual/estimated total row count 404 provided by the DBMS 112.

In another example, after the initial request 110 is processed by the mid-tier caching module 118, as described above in regards to FIG. 4A, a subsequent request may be received by the mid-tier caching module 118 with a data page specification 206 requesting the last 20 rows, i.e. rows 430-450, from the result set 402 of the currently active query. The mid-tier caching module 118 re-sends the query specification 202 to the DBMS 112 specifying that rows 400-500 of the result set 402 are to be returned, but expecting only 50 rows based on the actual/estimated total row count 404. However, if 25 rows have been deleted from the result set 402 in the interim, the DBMS 112 may return a data chunk 120 comprising the rows 400-425 from the query execution. The mid-tier caching module 118 may establish a new cache window in the mid-tier cache 122 and store the 25 rows from the data chunk 120 in the cache window, as indicated at 406 in FIG. 4I. The mid-tier caching module 118 may further update the actual/estimated total row count 404 for the result set 402 to indicate 425 rows. The mid-tier caching module 118 may then retrieve the requested rows 408 from the cache window 406 and return a data page 114 containing the retrieved rows and the updated actual/estimated total row count 404 to the user computing device 104.

However, if 75 rows have been deleted from the result set 402, the DBMS 112 may return no rows to the mid-tier caching module 118. In some embodiments, the mid-tier caching module 118 may request a new actual/estimated total row count 404 from the DBMS 112 for the result set 402, and return the update actual/estimated total row count 404 to the user computing device 104 with no rows of data. In additional embodiments, the mid-tier caching module 118 may further request the last 100 rows (cache size) from the result set 402 based on the new actual/estimated total row count 404 provided by the DBMS 112. A new cache window may be established in the mid-tier cache 122 with the 100 rows, as indicated at 406 in FIG. 4J. The mid-tier caching module 118 may then return the last 20 rows (page size) from the cache window 406 in a data page 114 to the user computing device 104 along with the updated actual/estimated total row count 404

Referring now to FIG. 5, additional details will be provided regarding the embodiments presented herein. It will be appreciated that the logical operations described with respect to FIG. 5 may be implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It will also be appreciated that more or fewer operations may be performed than shown in the figures and described herein. The operations may also be performed in a different order than described.

FIG. 5 illustrates one routine 500 for processing data page requests from a client utilizing a windowed mid-tier data cache, such as that described herein. The routine 500 may be performed by the mid-tier caching module 118, for example. It will be appreciated that the routine 500 may also be performed by other modules or components executing in the computer system 102 or in other computing devices, or by any combination of modules, components, and computing devices. The routine 500 begins at operation 502, where the mid-tier caching module 118 receives a request 110 for a data page 114. The request 110 may be received from a client application on the user computing device 104, for example. As described above in regard to FIG. 2, the request 110 may include a query specification 202 identifying a query to be executed by DBMS 112, a session identifier 204 to be associated with the request and subsequent requests, and a data page specification 206 indicating a row index and a row count for the data rows comprising the requested data page 114.

From operation 502, the routine 500 proceeds to operation 504, where the mid-tier caching module 118 determines whether the data rows specified by the data page specification 206 in the request 110 are currently contained in a cache window 406 associated with the request stored in the mid-tier cache 122. The cache window 406 may be associated with the request 110 by one or more of the session identifier 204, the query specification 202, and the like. In some embodiments, each data row in the cache window 406 has an associated row index indicating the row's position in the overall result set 402. The mid-tier caching module 118 may utilize the row index and a row count from the data page specification 206 and the row indices associated with the data rows in the cache window 406 to determine if all the data rows requested are contained in the mid-tier cache 122.

If all of the requested data rows are contained in the mid-tier cache 122, then the routine 500 proceeds to operation 516, where the mid-tier caching module 118 retrieves the rows specified in the data page specification 206 from the mid-tier cache 122, as described above in regard to FIG. 4B. If the requested data rows are not contained in the mid-tier cache 122, then the routine 500 proceeds to operation 506, where the mid-tier caching module 118 re-sends the query specification 202 or a query identifier to the DBMS 112 specifying that a number of data rows from the result set 402 encompassing the requested rows be returned.

The number of data rows requested from the DBMS 112 may match the cache size configured for the cache window 406 maintained in the mid-tier cache 122. The request to the DBMS 112 may further specify a beginning row index for the rows to be retrieved. For example, if the data page specification 206 in the request 110 from the user computing device 104 indicates that rows 90-110 from the result set 402 are desired, then the mid-tier caching module 118 may request that 100 data rows (cache size) starting at row index 60 be returned from the query execution in the DBMS 112, as described above in regard to FIG. 4C. The DBMS 112 may then return a data chunk 120 comprising the rows 60-160 from the query execution.

The routine 500 proceeds from operation 506 to operation 508, where the mid-tier caching module 118 determines whether the data chunk 120 returned by the DBMS contains the expected number or quantity of rows. As described above in regard to FIGS. 4G-4J, if an unexpected number of data rows is received from the DBMS 112, it may indicate that changes to the result set 402, such as inserts and deletes, have been made in the DBMS 112 external to the current session between the client application on the user computing device 104 and the mid-tier caching module 118. These changes will likely not be reflected in any cache window 406 maintained in the mid-tier cache 122 or in any status information associated with the cache window, such as the actual/estimated total row count 404. This may yield inconsistent rows in data pages 114 retrieved from the cache window 406 or over cache boundaries as the cache window is rebuilt from the DBMS 112, and may further affect accurate display of the paging UI controls in the UI 300, for example.

If the number of data rows returned from the DBMS 112 in the data chunk 120 matches the expected number of rows, then the routine 500 proceeds to operation 512 where the mid-tier caching module 118 establishes a new cache window 406 in the mid-tier cache 122 by storing the data rows received from the DBMS in the cache window, as described above in regard to FIGS. 4A, 4C, and 4D. If the number of data rows returned from the DBMS 112 in the data chunk 120 does not match the expected number of rows, then the routine 500 proceeds to operation 510, where the mid-tier caching module 118 updates the actual/estimated total row count 404 for the result set 402 maintained in conjunction with the cache window 406 in the mid-tier cache 122.

In some embodiments, if a new total number of data rows in the result set 402 can be inferred from the number of data rows returned by the DBMS 112 in the data chunk 120, such as in the scenarios described above in regard to FIGS. 4G and 4I, the mid-tier caching module 118 may calculate a new actual/estimated total row count 404 based on the number of data rows returned from the DBMS. However, if a new total number of data rows in the result set 402 cannot be inferred from the number of data rows returned by the DBMS 112, such as in the scenarios described above in regard to FIGS. 4H and 4J, the mid-tier caching module 118 may request a new actual/estimated total row count 404 for the result set from the DBMS 112.

In other embodiments, the mid-tier caching module 118 may request a new actual/estimated total row count 404 for the result set from the DBMS 112 any time the number of data rows returned from the DBMS does not match the expected number of rows. In further embodiments, the DBMS 112 may return an actual/estimated total row count 404 for the result set 402 with every data chunk 120 requested by the mid-tier caching module 118. It will be appreciated that in some embodiments, whether the actual/estimated total row count 404 returned by the DBMS 112 is an estimate or actual row count may be inconsequential, in that the actual total row count will be determined as the requested data rows reach those near the end of the result set 402. According to other embodiments, when the mid-tier caching module 118 determines that an estimate total row count provided by the DBMS 112 is invalid, the mid-tier caching module may request an actual total row count from the DBMS to properly manage the cache window 406 in the mid-tier cache 122 and to correct the actual/estimated total row count 404 returned to the client application on the user computing device 104 with the data page 114.

From operation 510, the routine 500 proceeds to operation 512, where the mid-tier caching module 118 stores the data rows from the data chunk 120 returned from the DBMS 112 in the cache window 406 in the mid-tier cache 122. The mid-tier caching module 118 may also update the status information associated with the cache window 406 accordingly. Next, the routine proceeds to operation 514, where the mid-tier caching module 118 may further cache associated image data in the image cache 124. As described above in regard to FIG. 1, the mid-tier caching module may request image data associated with the data rows returned in a data chunk 120 from the DBMS 112 and cache the image data in the image cache 124. The mid-tier cache module 118 may then respond to subsequent requests from the client application on the user computing device 104 for the cached images from the image cache 124.

From operation 514, the routine proceeds to operation 516, where the mid-tier caching module 118 retrieves the rows specified in the data page specification 206 of the request 110 from the cache window 406 in the mid-tier cache 122. As described above, the mid-tier caching module 118 may utilize the row indices associated with the data rows in the cache window 406 to determine the rows to retrieve to satisfy the request 110. From operation 516, the routine 500 proceeds to operation 518, where the mid-tier caching module 118 returns a data page 114 to the user computing device 104 containing the rows requested in the request 110. According to some embodiments, the mid-tier caching module 118 may also return the actual/estimated total row count 404 for the result set 402 associated with the cache window 406 in the mid-tier cache. The actual/estimated total row count 404 may be used by the client application on the user computing device 104 to update the paging UI controls in the UI 300, such as sizing and positioning the vertical scrollbar UI control 306 in the window 304 to reflect the number of total rows in the result set 402 and the relative position of the data rows visible in the window within the entire result set, for example. From operation 518, the routine 500 ends.

In additional embodiments, if all of the requested data rows are contained in the mid-tier cache 122, as determined at operation 504, the routine 500 proceeds to operation 520, wherein the mid-tier caching module 118 determines whether any image data associated with the requested data rows is contained in the image cache 124. If the associated image data is not contained in the image cache 124, then the routine 500 proceeds to operation 514, where the mid-tier caching module requests the image data associated with the requested data rows from the DBMS 112 and caches the image data in the image cache 124.

If the image data associated with the requested data rows is contained in the image cache 124, then the routine 500 proceeds to operation 516, where the mid-tier caching module 118 retrieves the requested data rows from the mid-tier cache 122 to be returned to the user computing device in the data page 114 at operation 518. The mid-tier cache module 118 may then respond to subsequent requests from the client application on the user computing device 104 for the cached image data from the image cache 124, as discussed above. From operation 518, the routine 500 ends.

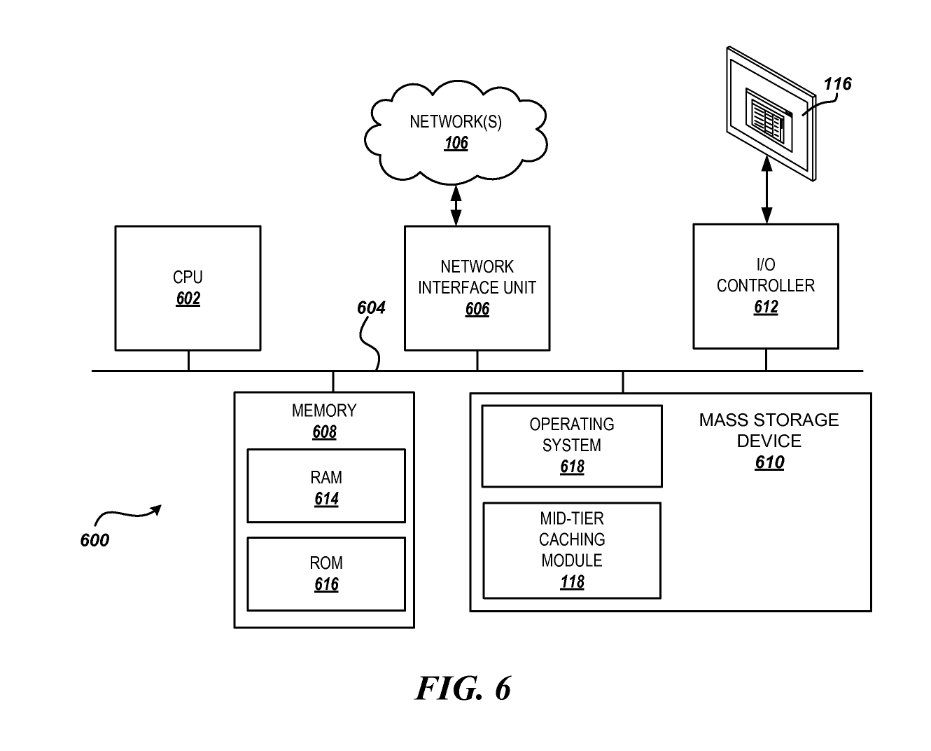

FIG. 6 shows an example computer architecture for a computer 600 capable of executing the software components described herein for implementing a windowed mid-tier data cache, in the manner presented above. The computer 600 shown in FIG. 6 illustrates a conventional server computer, a desktop computer, laptop, notebook, PDA, wireless phone, or other computer or computing device. The computer 600 in can be used to provide the functionality described herein with respect to the computer system 102, the user computing device 104, and/or any other computer or computing device. The computer 600 thus may be utilized to execute any aspects of the software components presented herein.

The computer 600 shown in FIG. 6 includes one or more central processing units (“CPUs”) 602. The CPUs 602 may be standard processors that perform the arithmetic and logical operations for the operation of the computer. The CPUs 602 perform the operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and other logic elements.

The computer architecture further includes a system memory 608, including a random access memory (“RAM”) 614 and a read-only memory 616 (“ROM”), and a system bus 604 that couples the memory to the CPUs 602. A basic input/output system containing the basic routines that help to transfer information between elements within the computer 600, such as during startup, may be stored in the ROM 616. The computer 600 also includes a mass storage device 610 for storing an operating system 618, application programs, and other program modules, which are described in greater detail herein.

The mass storage device 610 may be connected to the CPUs 602 through a mass storage controller (not shown) connected to the bus 604. The mass storage device 610 provides non-volatile storage for the computer 600. The computer 600 may store information on the mass storage device 610 by transforming the physical state of the device to reflect the information being stored. The specific transformation of physical state may depend on various factors, in different implementations of this description. Examples of such factors may include, but are not limited to, the technology used to implement the mass storage device, whether the mass storage device is characterized as primary or secondary storage, and the like.

For example, the computer 600 may store information to the mass storage device 610 by issuing instructions to the mass storage controller to alter the magnetic characteristics of a particular location within a magnetic disk drive, the reflective or refractive characteristics of a particular location in an optical storage device, or the electrical characteristics of a particular capacitor, transistor, or other discrete component in a solid-state storage device. Other transformations of physical media are possible without departing from the scope and spirit of the present description. The computer 600 may further read information from the mass storage device 610 by detecting the physical states or characteristics of one or more particular locations within the mass storage device.

As mentioned briefly above, a number of program modules and data files may be stored in the mass storage device 610 and RAM 614 of the computer 600, including an operating system 618 suitable for controlling the operation of a computer. The mass storage device 610 and RAM 614 may also store one or more program modules. In particular, the mass storage device 610 and the RAM 614 may store the mid-tier caching module 118, which was described in detail above in regard to FIG. 1. The mass storage device 610 and the RAM 614 may also store other types of program modules or data.

In addition to the mass storage device 610 described above, the computer 600 may have access to other computer-readable media to store and retrieve information, such as program modules, data structures, or other data. It will be appreciated by those skilled in the art that computer-readable media may be any available media that can be accessed by the computer 600, including computer-readable storage media and communications media. Communications media includes transitory signals. Computer-readable storage media includes volatile and non-volatile, removable and non-removable media implemented in any method or technology for the non-transitory storage of information, such as computer-executable instructions, data structures, program modules, or other data. For example, computer-readable storage media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and that can be accessed by the computer 600.

The computer-readable storage medium may be encoded with computer-executable instructions that, when loaded into the computer 600, may transform the computer system from a general-purpose computing system into a special-purpose computer capable of implementing the embodiments described herein. The computer-executable instructions may be encoded on the computer-readable storage medium by altering the electrical, optical, magnetic, or other physical characteristics of particular locations within the media. These computer-executable instructions transform the computer 600 by specifying how the CPUs 602 transition between states, as described above. According to one embodiment, the computer 600 may have access to computer-readable storage media storing computer-executable instructions that, when executed by the computer, perform the routine 500 for implementing a windowed mid-tier data cache, described above in regard to FIG. 5.

According to various embodiments, the computer 600 may operate in a networked environment using logical connections to remote computing devices and computer systems through the network(s) 106 described above in regard to FIG. 1 and/or other networks, such as a LAN, a WAN, the Internet, or a network of any topology known in the art. The computer 600 may connect to the network 620 through a network interface unit 606 connected to the bus 604. It will be appreciated that the network interface unit 606 may also be utilized to connect to other types of networks and remote computer systems.

The computer 600 may also include an input/output controller 612 for receiving and processing input from a number of input devices, including the touchscreen 116 described above, a keyboard, a mouse, a touchpad, an electronic stylus, or other type of input device. Similarly, the input/output controller 612 may provide output to a display device, such as the touchscreen 116, a computer monitor, a flat-panel display, a digital projector, a printer, a plotter, or other type of output device. It will be appreciated that the computer 600 may not include all of the components shown in FIG. 6, may include other components that are not explicitly shown in FIG. 6, or may utilize an architecture completely different than that shown in FIG. 6.

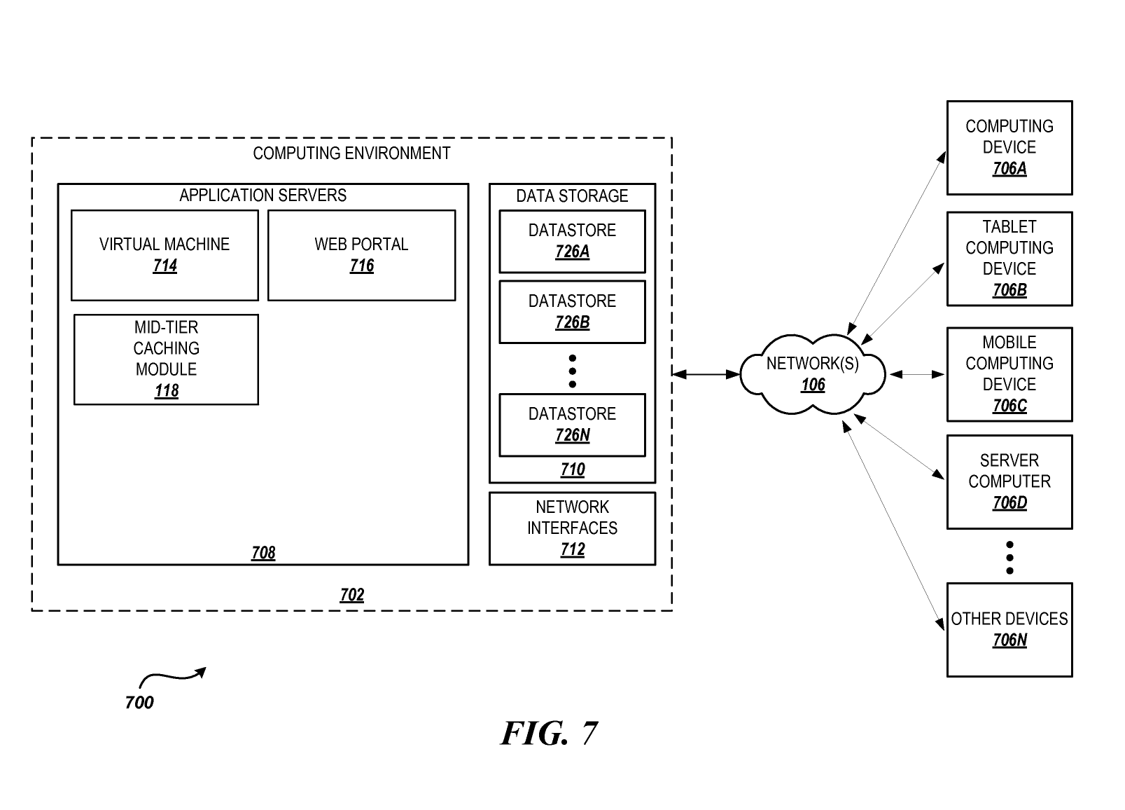

FIG. 7 illustrates an illustrative distributed computing environment 700 capable of executing the software components described herein for implementing a windowed mid-tier data cache, in the manner presented above. The distributed computing environment 700 illustrated in FIG. 7 can be used to provide the functionality described herein with respect to the computer system 102 and/or any other computing devices. The distributed computing environment 700 thus may be utilized to execute any aspects of the software components presented herein.

According to various implementations, the distributed computing environment 700 includes a computing environment 702 operating on, in communication with, or as part of the network(s) 106. The network(s) 106 may include various access networks. One or more client devices 706A-706N (hereinafter referred to collectively and/or generically as “clients 706”) can communicate with the computing environment 702 via the network(s) 106 and/or other connections (not illustrated in FIG. 7). In the illustrated embodiment, the clients 706 include a user computing device 706A, such as a laptop computer, a desktop computer, or other computing device; a tablet computing device 706B; a mobile computing device 706C such as a mobile telephone, a smart phone, or other mobile computing device; a server computer 706D; and/or other devices 706N, any of which may be represented by the user computing device 104 described above in regard to FIG. 1. It will be understood that any number of clients 706 can communicate with the computing environment 702. It will be understood that the illustrated clients 706 and computing architectures illustrated and described herein are illustrative, and should not be construed as being limited in any way.

In the illustrated embodiment, the computing environment 702 includes application servers 708, data storage 710, and one or more network interfaces 712. According to various implementations, the functionality of the application servers 708 can be provided by one or more server computers that are executing as part of, or in communication with, the network 704. The application servers 708 can host various services, virtual machines, portals, and/or other resources. In the illustrated embodiment, the application servers 708 host one or more virtual machines 714 for hosting applications or other functionality. According to various implementations, the virtual machines 714 host one or more applications and/or software modules for providing the functionality described herein. It will be understood that this embodiment is illustrative, and should not be construed as being limiting in any way. The application servers 708 may also host or provide access to one or more Web portals, link pages, Web sites, and/or other information (“Web portals”) 716.

As shown in FIG. 7, the application servers 708 also can host other services, applications, portals, and/or other resources. For example, the application servers 708 may host the mid-tier caching module 118, which was described in detail above in regard to FIG. 1. As mentioned above, the computing environment 702 can include the data storage 710. According to various implementations, the functionality of the data storage 710 is provided by one or more databases operating on, or in communication with, the network 704. The functionality of the data storage 710 also can be provided by one or more server computers configured to host data for the computing environment 702. The data storage 710 can include, host, or provide one or more real or virtual datastores 726A-726N (hereinafter referred to collectively and/or generically as “datastores 726”). The datastores 726 are configured to host data used or created by the application servers 708 and/or other data.

The computing environment 702 can communicate with, or be accessed by, the network interfaces 712. The network interfaces 712 can include various types of network hardware and software for supporting communications between two or more computing devices including, but not limited to, the clients 706 and the application servers 708. It will be appreciated that the network interfaces 712 also may be utilized to connect to other types of networks and/or computer systems.

It will be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the clients 706. It will be understood that the clients 706 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 700 to utilize the functionality described herein for implementing a windowed mid-tier data cache.

Based on the foregoing, it will be appreciated that technologies for implementing a windowed mid-tier data cache are provided herein. Although the subject matter presented herein has been described in language specific to computer structural features, methodological acts, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for implementing a windowed mid-tier data cache comprising:
receiving from a client application a request for a data page comprising a set of data rows from a result set of a query;
determining, by a computer system, whether the set of data rows exist in a cache maintained in the computer system;
upon determining that the set of data rows exist in the cache, retrieving, by the computer system, the set of data rows from the cache and returning the requested data page to the client application;
upon determining that the set of data rows does not exist in the cache, requesting, by the computer system, a data chunk from a database management system, the data chunk comprising a number of data rows from the result set larger than and encompassing the set of data rows;
upon receiving the data chunk from the database management system, storing, by the computer system, the data chunk in the cache; and
retrieving, by the computing system, the set of data rows from the data chunk stored in the cache and returning the requested data page to the client application.

2. The computer-implemented method of claim 1, wherein the data rows comprising the data chunk are substantially centered around the set of data rows in the result set.

3. The computer-implemented method of claim 1, further comprising returning a total row count for the result set.

4. The computer-implemented method of claim 3, wherein the total row count for the result set is retrieved from the database management system.

5. The computer-implemented method of claim 3, wherein the total row count for the result set is maintained in status information associated with the cache.

6. The computer-implemented method of claim 5, further comprising:
upon receiving the data chunk from the database management system, determining, by the computer system, whether the total row count is invalid based upon the number of data rows in the data chunk; and
upon determining that the total row count is invalid, updating the total row count.

7. The computer-implemented method of claim 6, wherein updating the total row count comprises calculating a new total row count based on the number of data rows comprising the data chunk received from the database management system.

8. The computer-implemented method of claim 6, wherein updating the total row count comprises requesting a new total row count for the result set from the database management system.

9. The computer-implemented method of claim 3, wherein the total row count is utilized by the client application to update one or more of a size and a position of a scrollbar UI control in a window to reflect a total number of data rows in the result set and a relative position of the set of data rows within the result set.

10. The computer-implemented method of claim 1, further comprising maintaining an image cache in the computer system in parallel with the cache, the image cache comprising cached image data associated with the data rows comprising the data chunk.

11. A computer-readable storage medium encoded with computer-executable instructions that, when executed in a computer system, cause the computer system to:
receive from a client application a first request for a first data page comprising a first set of data rows from a result set of a query;
request a first data chunk and a total row count for the result set from a database management system, the first data chunk comprising a number of data rows from the result set larger than and encompassing the first set of data rows;
upon receiving the first data chunk from the database management system, store the first data chunk in a cache;
retrieve the first set of data rows from the first data chunk stored in the cache and return the first data page and the total row count to the client application;
receive from the client application a second request for a second data page comprising a second set of data rows from the result set;
determine whether the second set of data rows exist in the first data chunk stored in the cache; and
upon determining that the second set of data rows exist in the first data chunk, retrieve the second set of data rows from the first data chunk stored in the cache and return the second data page and the total row count to the client application.

12. The computer-readable storage medium of claim 11, encoded with further computer-executable instructions that cause the computer to:
upon determining that the second set of data rows does not exist in the first data chunk, request a second data chunk from the database management system, the second data chunk comprising a number of data rows from the result set larger than and encompassing the second set of data rows;
upon receiving the second data chunk from the database management system, replace the first data chunk with the second data chunk in the cache; and
retrieve the second set of data rows from the second data chunk stored in the cache and return the second data page and the total row count to the client application.

13. The computer-readable storage medium of claim 12, encoded with further computer-executable instructions that cause the computer to:
upon receiving the second data chunk from the database management system, determine whether the total row count is invalid based upon the number of data rows comprising in the second data chunk; and
upon determining that the total row count is invalid, updating the total row count.

14. The computer-readable storage medium of claim 13, wherein updating the total row count comprises calculating a new total row count based on the number of data rows comprising the second data chunk received from the database management system.

15. The computer-readable storage medium of claim 13, wherein updating the total row count comprises requesting a new total row count for the result set from the database management system.

16. The computer-readable storage medium of claim 11, wherein the data rows comprising the first data chunk are substantially centered around the first set of rows in the result set.

17. The computer-readable storage medium of claim 11, wherein the total row count is utilized by the client application to update one or more of a size and a position of a scrollbar UI control in a window to reflect a total number of data rows in the result set and a relative position of the first set of data rows within the result set.

18. A method of navigating through data pages of a result set of a query, the method comprising:
sending, from a user computing device, a request for a data page to a mid-tier service, the request comprising a data page specification identifying a set of data rows from the result set comprising the data page and one or more of a query specification identifying the query and a session identifier identifying a session, wherein the mid-tier service is configured to maintain a cache window associated with the session in a mid-tier cache, the cache window comprising a quantity of data rows from the result set encompassing the set of data rows, the quantity greater than a number of rows in the set of data rows and less than a total number of data rows in the result set;
receiving, at the user computing device, the data page comprising the set of data rows and a total row count for the result set; the set of data rows retrieved from the cache window associated with the session;
displaying, on a display of the user computing device, the set of rows comprising the data page in a window; and
updating, at the user computing device, one or more of a size and a position of a scrollbar UI control in the window to reflect the total row count and a relative position of the set of data rows within the result set.

19. The method of claim 18, wherein the cache window in the mid-tier cache is associated with the session through the one or more of the query specification and the session identifier received in the request.

20. The method of claim 18, wherein the mid-tier service is further configured to, upon detecting that the set of data rows does not exist in the cache window:
send the query specification to a database management system;
request a data chunk from the database management system, the data chunk comprising a number of data rows from the result set larger than and encompassing the set of data rows;
replace the cache window associated with the session in the mid-tier cache with the data chunk;
retrieve the set of data rows from the data chunk comprising the cache window; and
return the requested data page to the user computing device.
